(19) United States
(12) Patent Application Publication
(10) Pub. No.: US 2024/0103931 A1
(43) Pub. Date: Mar. 28, 2024

(54) SCALING APPLICATION INSTANCES BASED ON LAG IN A MESSAGE BROKER

(71) Applicant: JPMorgan Chase Bank, N.A., New York, NY (US)

(72) Inventors: Prakash Ravi, Bear, DE (US); Maxwell Evers, Wilmington, DE (US); Amit Kumar Meshram, Romansville, PA (US); Sanjeev Medishetty, Middletown, DE (US)

(73) Assignee: JPMorgan Chase Bank, N.A., New York, NY (US)

(21) Appl. No.: 17/955,319

(22) Filed: Sep. 28, 2022

(51) Int. Cl. G06F 9/50; G06F 9/48; G06F 11/34; H04L 67/1001

(52) U.S. Cl. CPC G06F 9/5072; G06F 9/4881; G06F 11/3419; H04L 67/10015; G06F 9/546

(57) ABSTRACT

In one example, a method for dynamically scaling computer resources in a cloud computing environment is disclosed. The method includes determining lag state information of a message broker. The message broker handles real-time data exchanged with application instances running in a cloud service. The method includes determining whether the lag state information indicates a change to the application instances running in the cloud service. If the lag state information indicates a change, the method includes providing instructions to the cloud service to alter the application instances.

### BACKGROUND

A cloud computing environment may include multi-cloud deployment and geographically dispersed computing resources. This cloud computing environment type is dynamically scalable and offers on-demand access to configurable computing resources.

### BRIEF DESCRIPTION OF THE DRAWINGS

The drawings illustrate only particular examples of the disclosure and therefore are not to be considered to be limiting of their scope. The principles here are described and explained with additional specificity and detail through the use of the accompanying drawings.

FIG. 1 illustrates a cloud computing environment to dynamically scale application instances according to examples of the present disclosure.

FIG. 2 is a block diagram illustrating an autoscaler according to an example of the present disclosure.

FIG. 3 is a flow diagram illustrating an autoscaling method according to an example of the present disclosure.

FIG. 4 is a sequence diagram for autoscaling cloud instances according to an example of the present disclosure.

FIG. 5 is a block diagram of a lag configuration file according to an example of the present disclosure.

FIG. 6 is a block diagram of a computer system according to an example of the present disclosure.

### DETAILED DESCRIPTION

Cloud computing environment scalability can enable the provisioning of multiple instances of an application. For example, when applications and services are consuming data from application instances running in the cloud computing environment, the exchange of the data can be controlled by a message broker, e.g., Apache Kafka™. Based on the demands on the message service, however, it may be difficult to determine the number of application instances to instantiate in the cloud computing environment. The number of instances required to deliver reliable services may vary based on factors such as time of day, day of the week, unpredictable events, etc.

The present disclosure addresses the foregoing by providing a method, system, and computer program product for autoscaling applications instances running in a cloud computing environment based on the lag in the message broker. For some examples, a lag autoscaler can periodically query the message broker to determine the lag state currently occurring in the exchange of data. For instance, the lag state may represent the volume of data currently being handled by the message broker. The lag autoscaler can compare the lag state to lag configuration data for the message broker. Based on the comparison, the lag autoscaler can scale up or scale down the number of applications instances based on the current demands on the message broker.

In this manner, when the message broker is experiencing high volume, the present disclosure dynamically expands the computational resources of the cloud computing environment to meet demand. Likewise, if the volume is low, the present disclosure dynamically contracts the computational resources thereby freeing up resources and reducing overhead. As such, cloud computing resources can be efficiently utilized while still providing consistent and reliable service to the message broker.

In an example, a method for dynamically scaling computer resources in a cloud computing environment is disclosed. The method includes determining lag state information of a message broker. The message broker may handle real-time data exchanged with application instances running in a cloud service. The method includes using the lag state information to alter the number of application instances on the cloud service by retrieving a lag configuration record; and comparing information from the lag configuration record with the lag state information.

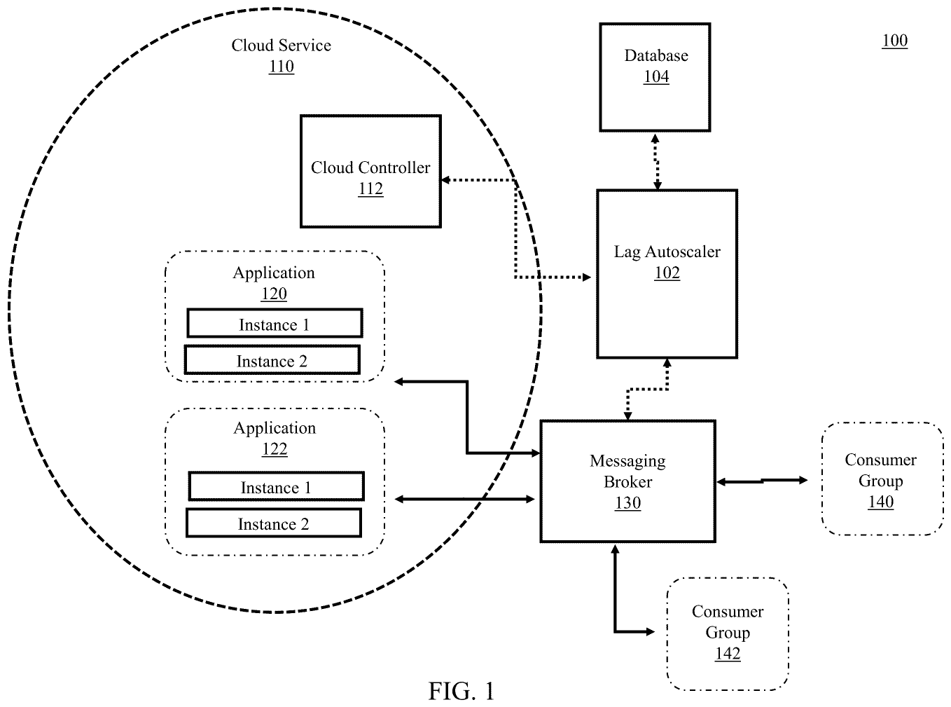

FIG. 1 illustrates a cloud computing environment 100 to automatically scale application instances using a lag autoscaler 102 according to examples of the present disclosure. While FIG. 1 illustrates various components contained in the cloud computing environment 100, FIG. 1 illustrates one example of a cloud computing environment of the present disclosure, and additional components can be added and existing components can be removed.

In the example of FIG. 1, the cloud computing environment 100 includes a cloud service 110 that is communicably coupled to the lag autoscaler 102 and messaging broker 130. In FIG. 1, the cloud service 110 can be a public cloud service, a private cloud service, or a hybrid (public/private) cloud service. For example, the cloud service 110 can be a public cloud such as AWS™ that is owned and/or operated by a public cloud vendor, in order to provide the services of the cloud to subscribers and customers. While the cloud computing environment 100 is illustrated as including one cloud service 110, the cloud computing environment 100 can include additional cloud services, and the arrangement and components of such a cloud computing environment can vary.

As used herein, a “cloud” or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In FIG. 1, the cloud service 110 can host multiple instances of applications, such as Instance 1 and Instance 2 of Application 120, and Instance 1 and Instance 2 of Application 122. The multiple instances of the application 120 and the application 122 can be controlled and managed by a cloud controller 112. The cloud controller 112 can include computer hardware, computer software, and combination thereof that instantiate the multiple instances of the application 120 and the application 122 and terminate the multiple instances of the application 120 and the application 122.

The cloud controller 112 can configure the multiple instances of the application 120 and the application 122 to be made available to users of the cloud service 110. The multiple instances of the application 120 and the application 122 can communicate with the cloud controller 112 via a standard application programming interface (API), or via other calls or interfaces. The multiple instances of the application 120 and the application 122 can likewise communicate with each other, as well as other sites, servers, locations, and resources available via the Internet or other public or private networks, whether within the cloud service 110 or outside of the cloud service.

Application 1 and Application 2 can be components of a distributed data store that is managed by a messaging broker 130. The messaging broker 130 operates the distributed data store optimized for ingesting and processing streaming data in real-time. The data, which is streamed, can be continuously generated by thousands of data sources, which typically send the data records in simultaneously. The messaging broker 130 operates to manage and control the continuous input and output of data, and to process the data sequentially and incrementally. The messaging broker 130 can provide functionality such as publishing and subscribing to streams of records; storing streams of records in the order in which records were generated; processing streams of records in real-time, and the like.

The messaging broker 130 can provide real-time data streaming pipelines that move data from one system to another. As shown in FIG. 1, the messaging broker 130 can provide the data pipelines between the instances of the application 120 and the consumer group 140, and between the instances of the application 122 and the consumer group 142. As described herein, a “consumer group” is one or more computer application, devices, or systems that utilize the messaging broker 130 to publish data to or consume data from the instances of the application running in the cloud service 110.

The number of instances of the application 120 and the number of the instances of the application 122 are selected to provide the data pipelines with reduced lag time to the consumer group 140 and the consumer group 142. However, the amount of data handled by the messaging broker 130 may vary based on several factors. That is, depending on the demand of the consumer group 140 and the consumer group 142 fewer or greater instances of the application 120 and the instances of the application 122 may be required. To achieve this, the lag autoscaler 102 can be configured to monitor the volume or lag in the messaging broker 130 and “scale”, e.g., reduce or increase, the number of instances of the application 120 and the application 122.

The lag autoscaler 102 can be configured to determine the lag in the messaging broker 130 by comparing the current volume of data in the messaging server 130 to a lag configuration file stored in a database 104. The lag autoscaler 102 can store a lag configuration file for each type of application, e.g., the application 120 and the application 122, currently running in the cloud service 110 and associated with the messaging broker 130.

The lag configuration file can specify, for each type of application, a threshold of lag or volume in data in the messaging broker 130 and the action to take, e.g., increase application instances and decrease application instances, if the threshold is crossed. If the threshold is crossed, the lag autoscaler 102 can be configured to provide a request to the cloud service to take the action defined in the lag configuration file, e.g., increase application instances or decrease application instances.

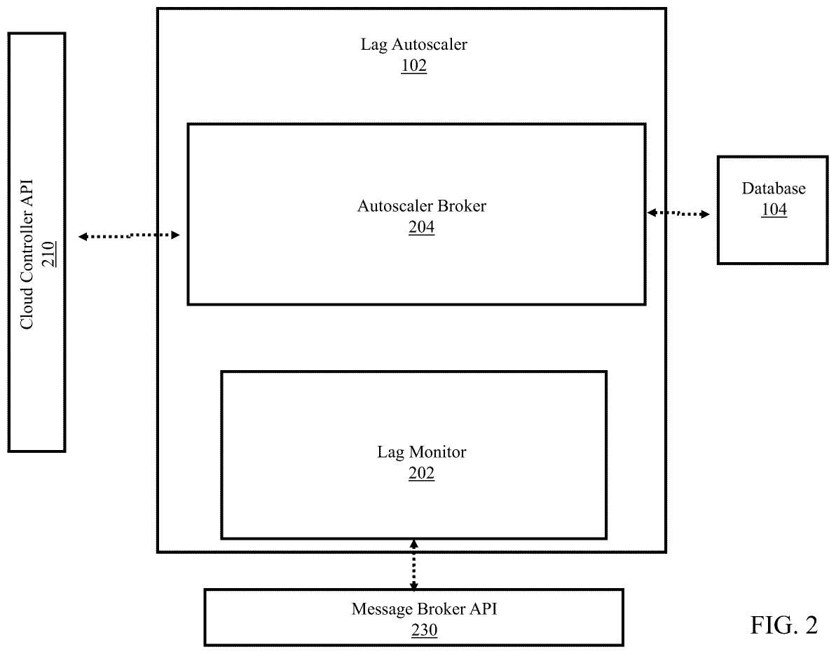

FIG. 2 is a block diagram of components of the lag autoscaler according to an example of the present disclosure. While FIG. 2 illustrates various components contained in the lag autoscaler 102, FIG. 2 illustrates one example of a lag autoscaler of the present disclosure, and additional components can be added and existing components can be removed.

In FIG. 2, the lag autoscaler 102 can be implemented as a software program or software application containing modules or components that are configured to perform the lag autoscaling as described herein. Likewise, the lag autoscaler 102 can be implemented as a portion of other software programs or applications. In either case, the lag autoscaler 102 can be configured to include the necessary logic, commands, instructions, and protocols to perform the processes and methods described herein. The lag autoscaler 102 can be written in any type of conventional programming language such as C, C++, JAVA, Perl, and the like. The lag autoscaler 102 can be executed on one or more computing systems or devices as described below. The computing systems or devices can be one more of any type of computing system capable of executing the lag autoscaler 102, such as servers, laptops, desktops, the cloud service 110, and the like. The computing system and devices can include several hardware resources, which are used to execute the lag autoscaler 102 such as processors, memory, network hardware and bandwidth, storage devices, etc., and a number of software resources, such as operating systems, application programs, software appliances, etc. The lag autoscaler 102 can be stored in computer-readable storage devices or media (CD, DVD, hard drive, flash drives, portable storage memory, etc.) whether local to the computing system and devices or remotely located.

The lag autoscaler 102 includes a lag monitor 202 and an autoscaler broker 204. The lag monitor 202 can be configured to communicate with the message broker 130, via a message broker API 230. The lag monitor 202, via the API 230, can fetch the current volume of data or data lag (hereinafter lag state information) being handled by the message broker 130. This can include the volume of data for each application 120 and 122 being handled by the message broker 130.

The lag monitor can be configured to transfer the lag state information to the autoscaler broker 204. In an example, the lag monitor 202 can be configured to publish the lag state information for retrieval by the autoscaler 102 and/or other components, devices, or systems.

The autoscaler broker 204 can be configured to retrieve the lag configuration file or files from the database 104 that correspond to the application 120 and the application 122. The autoscaler broker 204 can compare the lag state information to the configuration file or files for the application 120 and the application 122 to determine if action needs to be taken. Based on the comparison, if the autoscaler broker 204 determines that the message broker 130 is experiencing unacceptable lag, the autoscaler broker 204 can communicate with the cloud controller 110 via the cloud controller API 210 to increase or decrease the number of instances of the application 120 and/or the application 122. For example, if the message broker 130 is experiencing lag (volume above a threshold in one example), the autoscaler broker 204 can send a new application configuration, via the cloud controller API 210, to the cloud controller to add one or more new instances of the application 120 and/or the application 122.

In another example, if the message broker 130 not experiencing lag (volume above a threshold in one example), the autoscaler broker 204 can send a new application configuration, via the cloud controller API 210, to the cloud controller to terminate one or more new instances of the application 120 and/or the application 122.

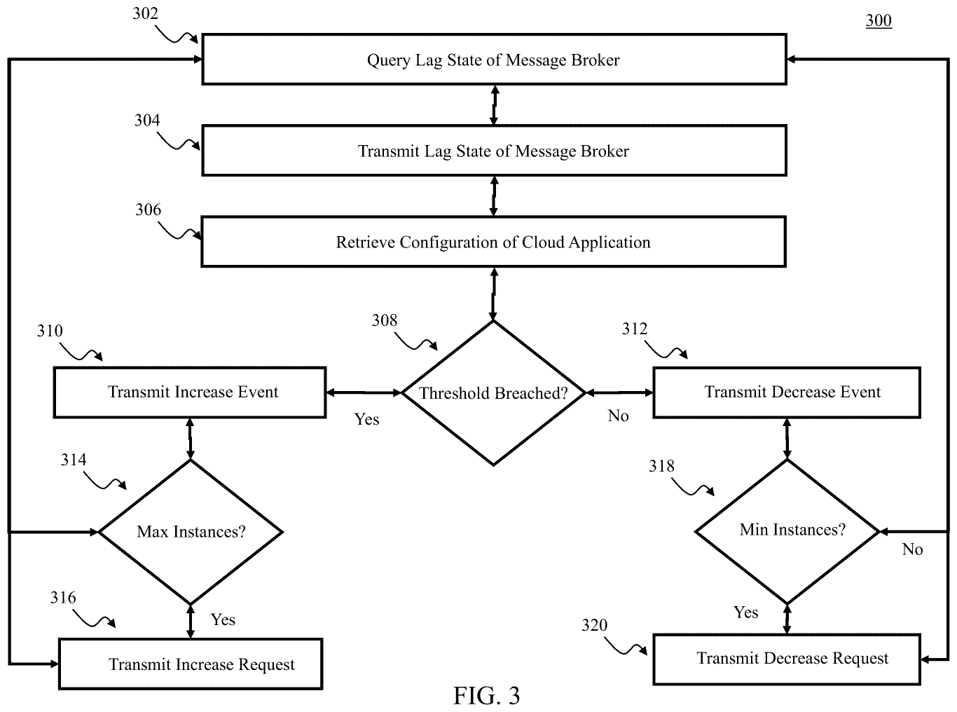

FIG. 3 is a flow diagram for a method 300 for autoscaling cloud instances based on lag according to an example of the present disclosure.

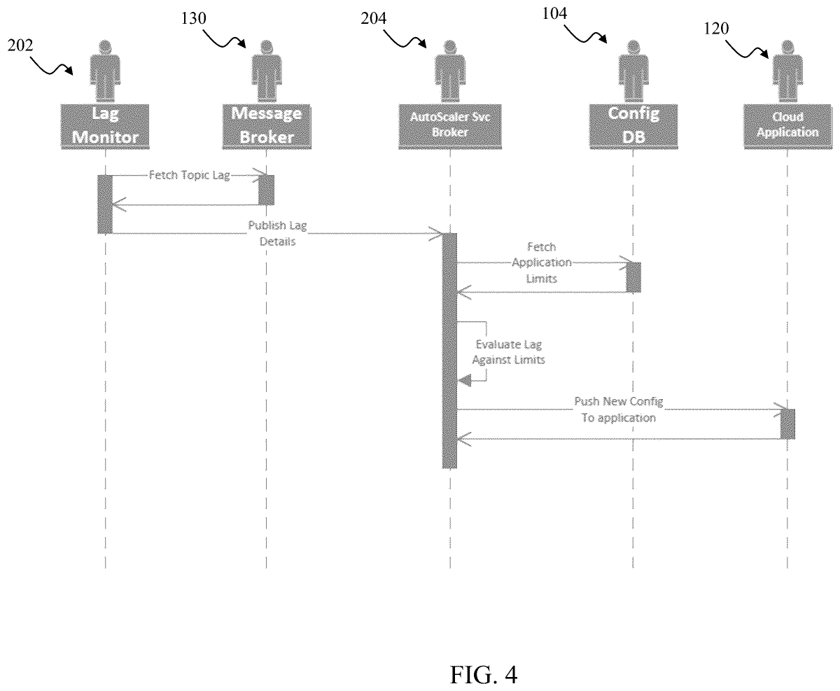

In 302, a lag state of the message broker is queried. For example, as illustrated in FIG. 4, which is a sequence diagram for autoscaling cloud instances based on lag according to an example of the present disclosure, the lag monitor 202 of the lag autoscaler 102 can fetch lag state information from the message broker 130, via the message broker API 230.

In 304, the lag state of the message broker is transmitted. For example, as illustrated in FIG. 4, the message broker 130, via the message broker API 230 can transmit the lag state information to the lag monitor 202. The lag state information can include information that specifies the current data load in the message broker 130. For example, the lag state information can include the number of messages that are currently queued in the message broker 130 for the application 120, and the number of messages that are currently queued in the message broker 130 for the application 122.

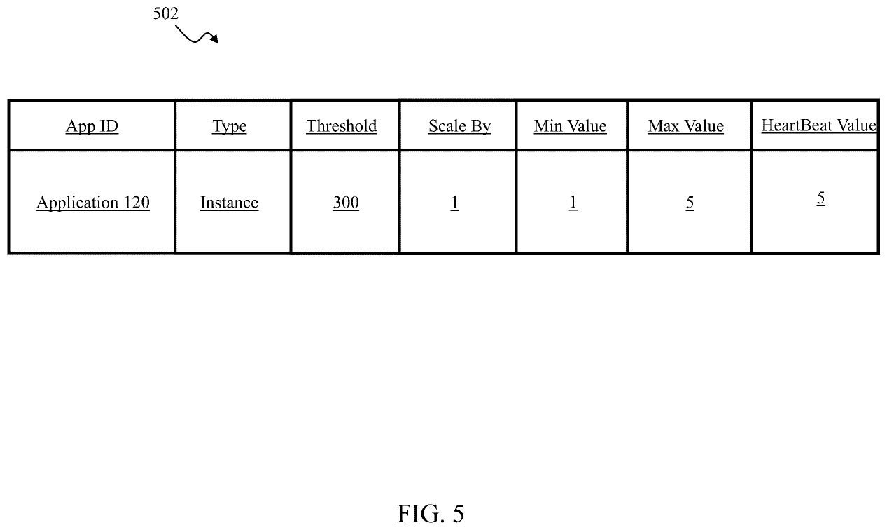

In 306, a configuration of a cloud application is retrieved. For example, the lag configuration file or files are retrieved from the database 104 that correspond to the application 120 and the application 122. FIG. 5 illustrates an example of a lag configuration file 502. As illustrated in FIG. 5, the lag configuration file 502 can include various fields that identify the application that corresponds to the lag configuration file 502 and information to determine if autoscaling is required.

The lag configuration file 502 can include a field that identifies the name of the application and the type of application, e.g., application 120 and instance type. The lag configuration file 502 also includes a field that defines a threshold. The threshold can represent the number of queued messages within the message broker 130. The lag configuration file 502 can include a field that identifies the number of instances to be scaled (increased or decreased) if the threshold is crossed. The lag configuration file 502 can include a field that identifies the number of instances to be scaled (increased or decreased) if the threshold is crossed. The lag configuration file 502 can include a field that identifies the maximum number of instances for the application and the minimum number of instances for the application.

The lag configuration file 502 can include a field that has a “heartbeat” value for the message broker. The heartbeat value is a counter threshold that signifies whether action should be taken by the autoscaler broker 204, as described below.

In 308, a determination is made whether a lag threshold has been reached. The autoscaler broker 204 can compare the lag state information to the configuration file or files for the application 120 and the application 122 to determine if action needs to be taken. For example, the autoscaler broker 204 compares the number of queued messages from the lag state information. If the volume is below the threshold, the autoscaler broker 204 decreases the heartbeat counter. If the volume is above the threshold, the autoscaler broker 204 increases the heartbeat counter.

In 310, if the lag threshold is reached, an increase event is transmitted. If the autoscaler broker 204 determines that the heartbeat counter reaches the value in the lag configuration file 502, the autoscaler broker 204 can communicate with the cloud controller to increase the number of application instances.

In 312, if the lag threshold has not been reached, a decrease event is transmitted. If the autoscaler broker 204 determines that the heartbeat counter reaches zero or a negative threshold value in the lag configuration file 502, the autoscaler broker 204 can communicate with the cloud controller to increase the number of application instances.

In 314, in response to the increase event, a determination is made whether a max number of instances has been reached. If the max number of instances has been reached, the process 300 returns to 302, and the lag state of the message broker is queried after a period of time. If the max number of instances has not been reached, in 316, an increase instances request is transmitted.

For example, if the message broker 130 is experiencing lag (volume above a threshold), the autoscaler broker 204 can send a new application configuration, via the cloud controller API 210, to the cloud controller to add one or more new instances of the application 120 and/or the application 122.

In 318, in response to the decrease event, a determination is made whether a minimum number of instances has been reached. If the minimum number of instances has been reached, the process 300 returns to 302, and the lag state of the message broker is queried after a period of time. If the minimum number of instances has not been reached, in 320 a decrease instances request is transmitted.

For example, if the message broker 130 not experiencing lag (volume above a threshold), the autoscaler broker 204 can send a new application configuration, via the cloud controller API 210, to the cloud controller to terminate one or more new instances of the application 120 and/or the application 122.

In this manner, the present disclosure can autoscale the number of application instances, in real time, thereby dynamically meeting the demands of the message broker. The autoscaling is seamless, efficient and requires less developer intervention.

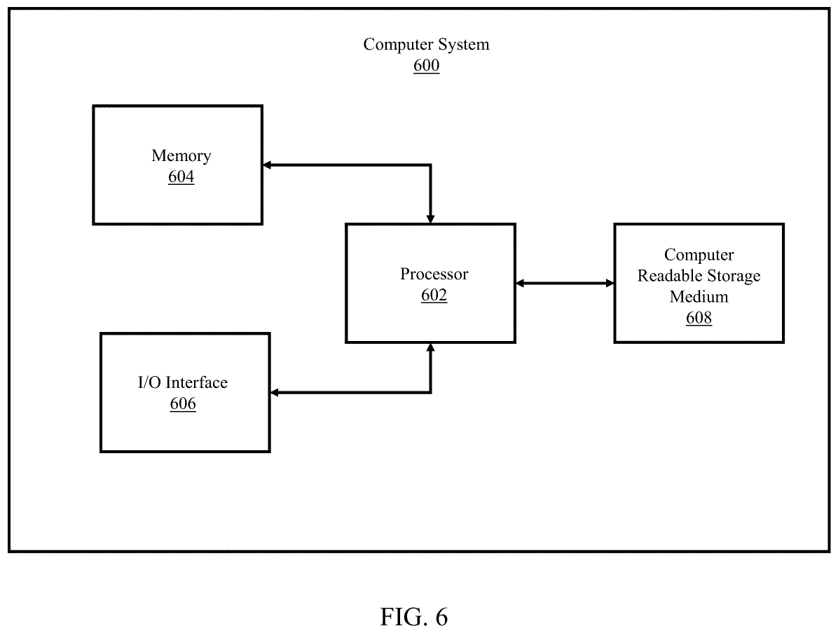

FIG. 6 is a block diagram of an example computer system 600 according to an example of the present disclosure. For example, the computer system 600 may be used to implement the lag autoscaler 102 of FIG. 1, as well as to provide computing resources as described herein. In some implementations, the computer system 600 may include a processor 602, a memory 604, and an input/output (I/O) interface 606. In various implementations, the processor 602 may be used to implement various functions and features described herein, as well as to perform the method implementations described herein. While the processor 602 is described as performing implementations described herein, any suitable component or combination of components of the computer system 600 or any suitable processor or processors associated with the computer system 600 or any suitable system may perform the steps.

The non-transitory computer-readable storage medium 608 may be any electronic, magnetic, optical, or other physical storage device that stores executable instructions. For example, the non-transitory computer-readable storage medium 608 may be random access memory (RAM), an electrically-erasable programmable read-only memory (EEPROM), a storage drive, an optical disc, or the like. The non-transitory computer-readable storage medium 608 can be encoded to store executable instructions that cause a processor to perform operations according to examples of the disclosure.

Examples of the present disclosure may include a computer program product having a non-transitory, computer-readable storage medium (e.g., 608) having instructions stored thereon. The instructions may be executed by a processor 602 adapted to perform operations including: determining lag state information of a message broker (e.g. messaging broker 130 of FIG. 1). The message broker is to handle real-time data exchanged with application instances (e.g., Instances 1 and 2 of Application 120 of FIG. 1) running in a cloud service (e.g. 110 of FIG. 1). The operations may include determining whether the lag state information indicate a change to the application instances running in the cloud service; and in response to determining whether the lag state information indicates a change, providing instructions to the cloud service to alter the number of application instances.

For some examples, using the lag state information to alter the number of application instances on the cloud service may include determining that the counter exceeds an upper counter threshold; determining whether a number of application instances exceeds a maximum; and in response to the number of application instances not exceeding the maximum, instructing the cloud service to instantiate one or more new application instances.

For some examples, a system for dynamically scaling computer resources is disclosed. The system includes a processor; and at least one computer readable storage medium storing instructions. The processor is configured to execute the instructions to perform a method comprising: determining lag state information of a message broker, wherein the message broker handles real-time data exchanged with application instances running in a cloud service; determining whether the lag state information indicate a change to the application instances running in the cloud service; and in response to determining the whether the lag state information indicates a change to the application instances running in the cloud service, providing instructions to the cloud service to alter the number application instances.

The present disclosure may employ a software stack to enlist the underlying tools, frameworks, and libraries used to build and run example applications of the present disclosure. Such a software stack may include PHP, React, Cassandra, Hadoop, Swift, etc. The software stack may include both frontend and backend technologies including programming languages, web frameworks servers, and operating systems. The frontend may include JavaScript, HTML, CSS, and UI frameworks and libraries. In one example, a MEAN (MongoDB, Express.js, Angular JS, and Node.js) stack may be employed. In another example, a LAMP (Linux, Apache, MySQL, and PHP) stack may be utilized.

Any suitable programming language can be used to implement the routines of particular examples including Java, Python, JavaScript, C, C++, assembly language, etc. Different programming techniques can be employed such as procedural or object oriented. The routines may execute on specialized processors.

The specialized processor may include memory to store a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a software program.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

1. A computer program product having a non-transitory, computer-readable storage medium having instructions stored thereon, which when executed by a processor, causes the processor to perform operations comprising:
determining a lag state of a message broker, wherein the message broker handles real-time data exchanged with application instances of multiple applications running in a cloud service;
for each application of the multiple applications, determining whether the lag state indicates a change to the application instances of the application running in the cloud service; and
in response to determining whether the lag state indicates a change to the application instances of at least one application of the multiple applications, providing instructions to the cloud service to alter the number of application instances of the at least one application.

2. (canceled)

3. The computer program product of claim 1, wherein the operation of determining the lag state of the message broker further comprises: fetching lag state information from the message broker via an application programming interface.

4. The computer program product of claim 3, wherein the lag state information comprises a volume of data messages currently queued by the message broker for each application of the multiple applications.

5. The computer program product of claim 1, wherein the operation of determining whether the lag state indicates a change to the application instances of the at least one application running in the cloud service further comprises, for each application of the multiple applications:
retrieving a lag configuration record for the application; and
comparing information from the lag configuration record for the application to the lag state.

6. The computer program product of claim 5, wherein, for each application of the multiple applications, the operation of comparing information from the lag configuration record for the application to the lag state further comprises:
retrieving a volume threshold from the lag configuration record for the application;
comparing the volume threshold to a volume of data messages currently queued by the message broker for the application;
incrementing a counter if the volume of data messages is greater than the volume threshold; and
decrementing the counter if the volume of data messages is lower than the volume threshold.

7. The computer program product of claim 6, wherein the operation of providing instructions to the cloud service comprises:
determining that the counter exceeds an upper counter threshold for the at least one application;
determining whether a number of application instances exceeds a maximum for the at least one application; and
in response to the number of application instances of the at least one application not exceeding the maximum, instructing the cloud service to instantiate a new application instance of the at least one application.

8. The computer program product of claim 7, wherein the operation of providing instructions to the cloud service comprises:
determining that the counter is below a lower counter threshold;
determining whether a number of application instances is below a minimum for the at least one application; and
in response to the number of application instances of the at least one application not being below the minimum, instructing the cloud service to terminate an application instance of the at least one application.

9. A method for dynamically scaling application instances of multiple applications in a cloud computing environment, the method comprising:
determining a lag state of a message broker, wherein the message broker handles real-time data exchanged with the application instances of the multiple applications running in a cloud service; and
for each application of the multiple applications, using the lag state information to determine whether to alter the number of application instances of the application running on the cloud service.

10. The method of claim 9, wherein determining the lag state of the message broker comprises:
using an application programming interface to request lag state information from the message broker.

11. The method of claim 10, wherein the lag state information comprises a volume of data messages currently queued by the message broker for each application of the multiple applications.

12. The method of claim 9, wherein, for each application of the multiple applications, using the lag state information to determine whether to alter the number of application instances of the application running on the cloud service further comprises:
retrieving a lag configuration record for the application; and
comparing information from the lag configuration record for the application to the lag state information.

13. The method of claim 12, wherein, for each application of the multiple applications, comparing information from the lag configuration record for the application to the lag state information, comprises:
retrieving a volume threshold from the lag configuration record for the application;
comparing the volume threshold to a volume of data messages currently queued by the message broker for the application;
incrementing a counter if the volume of data messages is greater than the volume threshold; and
decrementing the counter if the volume of data messages is lower than the volume threshold.

14. The method of claim 13, wherein, for each application of the multiple applications, using the lag state information to determine whether to alter the number of application instances of the application running on the cloud service further comprises:
determining that the counter exceeds an upper counter threshold for the application;
determining whether a number of application instances exceeds a maximum for the application; and
in response to the number of application instances of the application not exceeding the maximum, instructing the cloud service to instantiate a new application instance.

15. The method of claim 14, wherein, for each application of the multiple applications, instructing the cloud service to instantiate one or more new application instances, comprises:
determining that the counter is below a lower counter threshold;
determining whether a number of application instances is below a minimum for the application; and
in response to the number of application instances of the application being above the minimum, instructing the cloud service to terminate an application instance of the application.

16. A system for dynamically scaling application instances of multiple applications, the system comprising:
a processor; and
at least one computer readable storage medium storing instructions, wherein the processor is configured to execute the instructions to perform a method comprising:
determining lag state of a message broker, wherein the message broker handles real-time data exchanged with the application instances of the multiple applications running in a cloud service;
for each application of the multiple applications, determining whether the lag state indicates a change to the application instances of the application running in the cloud service; and
in response to determining whether the lag state indicates a change to the application instances of at least one application of the multiple applications, providing instructions to the cloud service to alter the number application instances of the at least one application.

17. The system of claim 16, wherein determining whether the lag state indicates a change to the application instances of the at least one application comprises, for each application of the multiple applications:
retrieving a lag configuration record for the application; and
comparing information from the lag configuration record for the application to the lag state.

18. The system of claim 17, wherein, for each application of the multiple applications, comparing information from the lag configuration record for the application to the lag state, comprises:
retrieving a volume threshold from the lag configuration record for the application;
comparing the volume threshold to a volume of data messages currently queued by the message broker for the application;
incrementing a counter if the volume of data messages is greater than the volume threshold; and
decrementing the counter if the volume of data messages is lower than the volume threshold.

19. The system of claim 18, wherein providing instructions to the cloud service, comprises:
determining that the counter exceeds an upper counter threshold for the at least one application;
determining whether a number of application instances exceeds a maximum for the at least one application; and
in response to the number of application instances of the at least one application not exceeding the maximum, instructing the cloud service to instantiate a new application instance of the at least one application.

20. The system of claim 19, wherein providing instructions to the cloud service, comprises:
determining that the counter is below a lower counter threshold;
determining whether a number of application instances is below a minimum for the at least one application; and
in response to the number of application instances of the at least one application being above the minimum, instructing the cloud service to terminate an application instance of the at least one application.
